(19) United States
(12) Patent Application Publication
(10) Pub. No.: US 2021/0016116 A1
(43) Pub. Date: Jan. 21, 2021

(54) Safety Check Apparatus for Challenge Course

(71) Applicant: JiMi IP, LLC, Allegan, MI (US)

(72) Inventors: James Allen LIGGETT, Allegan, MI (US); Sean Raymond HORIHAN, Allegan, MI (US); Caitlin Marie MCMAHAN, Allegan, MI (US)

(21) Appl. No.: 16/961,499

(22) PCT Filed: Sep. 25, 2019
(86) PCT No.: PCT/US2019/052832

§ 371 Date: Jul. 10, 2020

Related U.S. Application Data
(60) Provisional application No. 62/736,214, filed on Sep. 25, 2018.

(51) Int. Cl. A62B 35/00

(52) U.S. Cl. CPC A62B 35/0062; A63B 71/0054; A62B 35/0087; A62B 35/0075

(57) ABSTRACT

A safety check apparatus and method for testing a lanyard system prior to entering a challenge course. The apparatus comprises a track arranged at an entrance of the challenge course. The track includes a first position and a second position above a supporting surface. A moveable member is supported by and displaceable relative to the track. The track is connected to a course track that traverses the challenge course such that the moveable member is displaceable therebetween. A lanyard is attached to the moveable member and extends a length from the moveable member. A user harness is coupled to the lanyard. When at least a portion of a user's weight is supported by the harness, the connection point between the harness and the lanyard is positioned higher above the supporting surface at the second position of the track than at the first position of the track.

### BACKGROUND

Challenge courses are structures that allow a person or persons to traverse a course comprising elements or obstacles. For example, challenge courses may be used for military training or recreation. Elements or obstacles are typically provided between platforms along the course, and may include, for example, various arrangements of ropes, cables, planks, beams, steps, angled surfaces, climbing walls and the like, alone or in combination. In some challenge courses, users may quickly descend along inclined fixed tracks or zip lines incorporated into the course. Further, challenges courses are often provided at an elevation above ground level or include multiple levels that increase the height of the structure, which augments the overall thrill and sense of danger experienced navigating the course. Accordingly, depending on the particular structural configuration, a challenge course may carry an inherent risk of injury or death in the event that a user loses his or her balance, slips off, or otherwise falls from the elements or obstacles.

To mitigate this risk, users may be required to wear a harness which is then connected to a lanyard, such as by a carabiner, that is secured to a moveable member mounted within a track of the challenge course. Once fitted with such lanyard systems, users are generally allowed to proceed directly onto the challenge course. However, the risk of accidents during the actual operation of the challenge course nonetheless remains due to the innate possibility of human error, including in course personnel initially equipping users before the users enter the challenge course. Even where course operators are trained to follow specified procedures to hook users into the course and to inspect whether the attachment was done correctly, inevitable mistakes, lapses in concentration, and environmental distractions during this process can result in the user not being properly attached to course components. Further, the error may not be identified until a catastrophic failure occurs. For example, an oversight in securing the lanyard to the harness, or improperly coupling the lanyard to the harness with the carabiner, may not be immediately noticed since in some configurations the lanyard is pulled through a loop of the harness before being securely attached to the harness, in which case the lanyard would still be pulled along the track as the user navigates the course but would not provide any actual support to catch the user in the event of a. slip or fall. This can cause serious injury or death, particularly if the failure occurs when the user is high above ground level. Therefore, a need exists for additional operational safeguards to ensure users are safely engaged with challenge course equipment and components.

The foregoing examples of the related art and limitations therewith are intended to be illustrative and not exclusive. Other limitations of the related art will become apparent to those of skill in the art upon a reading of the specification and a study of the drawings.

### SUMMARY

In view of the foregoing, the present disclosure relates to means for checking whether the components of a user's lanyard system are properly connected to the course tracking and to each other, in a relatively safe and controlled setting. Accordingly, an aspect is to provide a safety check apparatus for testing a lanyard system to determine whether a user is correctly attached to the overhead tracking before the user enters the challenge course and starts traversing elevated course elements or obstacles. Another aspect relates to a method for testing a lanyard system to determine whether the user is correctly attached to the overhead tracking before the user enters the challenge course and starts traversing elevated course elements or obstacles.

The safety check apparatus comprises a track arranged at an entrance of the challenge course above a supporting surface. The safety check apparatus further comprises a moveable member and a lanyard for forming an attachment between the user and the track. The moveable member is supported by the track and displaceable relative to the track. The lanyard is attached to the moveable member and extends a length from the moveable member to attach to a harness worn by a user. The harness has at least one connection point for coupling to at least one connection point of the lanyard. The harness may be coupled to the lanyard via one or more carabiners, for example. Preferably, the track is connected to a course track that traverses the challenge course such that the moveable member is displaceable between the safety check apparatus track and the challenge course track. In some embodiments, the track of the safety check apparatus is integral with and transitions into the course track of the challenge course.

The track of the safety check apparatus has at least a first position and a second position, with the first position being a first vertical distance above the supporting surface, and the second position being a second vertical distance above the supporting surface. The first vertical distance of the first position of the track is shorter than the second vertical distance of the second position of the track. The first vertical distance of the first position of the track is longer than the length of the lanyard. The second vertical distance of the second position of the track is longer than the length of the lanyard. The second position of the track may be arranged between the course track and the first position of the track. Alternatively, the first position of the track may instead be arranged between the course track and the second position of the track. In other embodiments, the track of the safety check apparatus is not connected to a course track that traverses the challenge course, in which case, the user's lanyard system would be transferred to the course track after being tested.

In testing the lanyard system, a load provided by a user's weight is introduced into the harness at the second position of the track. At least a portion of the user's weight is loaded onto the harness. If the lanyard system passes the test, then the components that attach the user to the track will support the weight of the user loaded onto the harness. In that case, the length of the lanyard will be pulled taut between the moveable member, which is secured with respect to the track above, and the lanyard's connection point to the loaded harness. If the lanyard system fails the test, then the components that attach the user to the track will not support the weight of the user loaded onto the harness. In that case, the user's weight is otherwise transferred to the supporting surface below. For example, the user may fall to the supporting surface in the event of a failed test.

Depending on the embodiment, the user may or may not be able to reach the supporting surface at the second position of the track when the user's weight is supported by the lanyard system. In some embodiments, the second vertical distance, which extends between the supporting surface and the second position of the track, is configured to prevent the user's feet from contacting the supporting surface when the user's weight is loaded onto the harness and the user is supported by the components that attach the user to the track. In other embodiments, the second vertical distance is configured to allow the user's feet to remain in contact with the supporting surface when the user's weight is loaded onto the harness and the user is supported by the components that attach the user to the track. Therefore, it should be appreciated that all the user's weight may not necessarily be transferred to the components which comprise the lanyard system that attaches the user to the track during the test namely, the harness, the lanyard, the moveable member, and any connection pieces therefor since at least some of the user's weight is supported by the supporting surface where the user's feet are still touching the supporting surface during the test. In either case, if the lanyard system is properly connected and functioning, then the user's weight will be completely or at least partially supported by the components that attach the user to the track. In this way, the safety check apparatus may be used to check whether the user is safely attached to the track.

It should be appreciated that, in theory, increasing the load introduced into the lanyard system during testing may result in more reliable test results, since the load threshold for a catastrophic failure of a defective component could potentially be higher than the force introduced by only part of the user's weight but lower than the force introduced when a user falls completely off an element of the challenge course where the lanyard system must support the user's entire weight. Preferably, the second vertical distance is configured to load at least a majority of the user's weight onto the harness when the user is supported by the harness at the second position of the track. In some embodiments, the second vertical distance of the second position of the track is configured to load at least 75% of the user's weight onto the harness when the user is supported by the harness at the second position of the track. In further embodiments, the second vertical distance of the second position of the track is configured to load at least 95% of the user's weight onto the harness when the user is supported by the harness at the second position of the track. In still further embodiments, the second vertical distance of the second position of the track is configured to load all the user's weight onto the harness when the user is supported by the harness at the second vertical position of the track.

The user's weight may be loaded into the harness in various ways depending on the embodiment. In general, the user's weight is introduced into the harness by either a movement performed by the user or a movement performed by the safety check apparatus. For example, the user may sit down in the harness or lean in a direction to load the harness. Or the harness may be hoisted to lift the user. Regardless of the means by which the user's weight is introduced into the lanyard system, the connection point of harness coupled to the lanyard is positioned higher above the supporting surface at the second position of the track than at the first position of the track when the user's weight is supported by harness.

In some embodiments, the difference between the first vertical distance of the first position of the track and the second vertical distance of the second position of the track corresponds to the height that a user falls when the user steps or falls off an element of the challenge course before being caught by the lanyard, which is coupled to the harness and secured with respect to the course track traversing the challenge course via the moveable member. For example, the difference may be the same or substantially the same where the second vertical distance is configured to prevent the user from contacting the supporting surface. Where the harness is to be coupled to the lanyard at the second track position, the difference between the first vertical distance of the first position of the track and the second vertical distance of the second position of the track may be slightly less than the height that a user falls when the user steps or falls off an element of the challenge course before being caught by the lanyard, in order to provide the lanyard with enough slack to connect the lanyard to the harness and to move the moveable member along the track at the second position of the track.

In some embodiments, the first vertical distance of the first position of the track above the supporting surface is selected to make it easier for users and operators to reach the lanyard and move the moveable member connected to the lanyard along the track, at least compared to the second vertical distance of the second position of the track. In some embodiments, the first vertical distance of the first position of the track above the supporting surface is the same as the height between an element of the challenge course and a course track traversing said element. Such configurations may be used to facilitate a transition between the first position of the track of the safety check apparatus and the course track traversing the challenge course at the entrance to the challenge course, as well as to improve the maneuverability of the lanyard system through the first position of the track.

In some embodiments, the second vertical distance of the second position of the track above the supporting surface is selected to make it easier for a user to move from sitting in the harness to standing on the supporting surface, at least compared to the first vertical distance of the first position of the track. Such configurations are preferable where the user will stand back up on the supporting surface at the second position of the track after being tested.

In some embodiments, the lanyard comprises a plurality of connection points for coupling to the harness, and the connection point of the harness is coupled to the first adjacent connection point of the lanyard which is below the connection point of the harness when a user wearing the harness is standing under the second position of the track and the length of the lanyard is pulled downward from the moveable member in the track above. The height between this preferred connection point of the lanyard and the supporting surface at the second position of the track corresponds to the amount of slack in the lanyard when the user is on a course element of the course track, so long as the height between the course element and the course track is greater than the second vertical distance of the second position of the track. Therefore, the second vertical distance of the second position of the track may be used to provide the lanyard with a desired amount of slack for traversing the challenge course, whereby too much slack can present a safety hazard with respect to the user becoming entangled with the lanyard or as to an excessive height that the user will fall from the element before being caught by the lanyard, while not enough slack can impede the user's ability to navigate elements and to move the lanyard system along the course track due to friction between the moveable member and course track if the lanyard is too taut. In this way, the connection point of the harness can be coupled along the length of lanyard to the preferred connection point of the lanyard for that particular challenge course and user. Shorter users can be coupled to the lanyard using the lower connection points of the lanyard compared to taller users, who can be coupled to the lanyard using higher connection points of the lanyard, yet the amount of slack in the lanyard while each user is on the course track is the same.

In one embodiment of the safety check apparatus, the track is inclined between a first portion of the track and a second portion of the track, with the second portion of the track being vertically higher than the first portion of the track. In this configuration, the first position of the track is located in the first portion of the track, and the second position of the track is located in the second portion of the track.

In another embodiment of the safety check apparatus, the supporting surface comprises a platform arranged underneath the track that is displaceable between a first height and a second height, with the first height of the platform being vertically higher than the second height of the platform. In this configuration, the first position of the track is located above the platform when the platform is at the first height, and the second position of the track is located above the platform when the platform is at the second height. The platform may be displaced between the first height and the second height by a hydraulic lift or hoist, a traction lift or hoist, or any other suitable mechanism for moving the platform up or down. In some embodiments, the second vertical distance, which extends between the track and the platform when the platform is positioned at the second height, is configured to prevent a user's feet from contacting the platform when the platform is lowered to the second height.

In another embodiment of the safety check apparatus, the supporting surface comprises a vertical dip. In this configuration, the second position of the track is located above the vertical dip of the supporting surface, and the first position of the track is located above the supporting surface horizontally adjacent to the vertical dip.

In another embodiment of the safety check apparatus, the supporting surface comprises an elevated platform underneath the track, the track comprises a rail portion arranged above the supporting surface horizontally adjacent to the elevated platform, and the moveable member comprises one or more wheels configured to roll along the rail portion of the track. In this configuration, the first position of the track is located above the elevated platform, and the second position of the track is located in the rail portion of the track. In a modification of this embodiment, the supporting surface comprises a vertical dip along the rail portion of the track similar to the previous embodiment, in which case the first position and the second position of the track may share the same or substantially the same vertical position, with the first position of the track being located above the supporting surface horizontally adjacent to the vertical dip. With this modification, the elevated platform may be omitted entirely. In some embodiments, the second vertical distance, which extends between the supporting surface and the rail portion of the track, is configured to prevent a user's feet from contacting the supporting surface when a user rolls along the rail portion of the track.

In another embodiment of the safety check apparatus, the track comprises a moveable portion that is displaceable between a first height and a second height, with the second height of the moveable portion being vertically higher than the first height of the moveable portion. The moveable portion of the track provides the first position of the track when the moveable portion is at the first height. The moveable portion of the track provides the second position of the track when the moveable portion is at the second height. If the track of the safety check apparatus is connected to a course track that traverses the challenge course, the track may transition into the course track when the moveable portion is positioned at the first height. The moveable portion may be displaced between the first height and the second height by a hydraulic lift or hoist, a traction lift or hoist, or any other suitable mechanism for moving the moveable track section up or down. In some embodiments, the second vertical distance, which extends between the supporting surface and the moveable portion of the track when the moveable portion of the track is positioned at the second height, is configured to prevent a user's feet from contacting the supporting surface when the moveable portion of the track is raised to the second height.

In any of the embodiments described herein, the track may be connected to the course track traversing the challenge course at a course track ingress point. In some embodiments, the track has a test exit gate that is interchangeable between an open and closed position, with the test exit gate being arranged between the course track ingress point and the second position of the track. The test exit gate is configured to prevent a user from proceeding forward from the second position of the track to the course track until the user has completed testing. Additionally or alternatively, the track may have a test entry gate that is interchangeable between an open and closed position, with the second position of the track being arranged between the course track ingress point and the test entry gate. The test entry gate is configured to prevent a user from proceeding forward to the second position of the track until a previous user has completed testing. Both the test exit gate and the test entry gate may be arranged inside or outside of the pathway that the moveable member occupies when the moveable member is displaced along the track. For example, either gate can be arranged within the track and configured to block movement of the moveable member along the track, or arranged adjacent to the track and configured to block movement of the lanyard along the track. Further, either gate may be configured to block the movement of the user, rather than the lanyard system, along the track such as in the manner of a turnstile gate or other similar physical gate. Accordingly, any configuration designed to selectively block movement of the user or the lanyard system, or any connection pieces thereof, may be used for the test exit and test entry gates. In some embodiments, the safety check apparatus comprises an indicator configured to visibly indicate when the test exit gate and/or the test entry gate is/are open and/or closed. In this way, the indicator communicates a testing status to users, which can be used to automatically direct users through the system in an efficient manner. The indicator could also provide audible signals to users, in addition to or instead of visible signals, depending on the embodiment. In some embodiments, the safety check apparatus has a logic controller which controls operation of the test exit gate, the test entry gate, and/or the indicator based on input received from one or more sensors or from course personnel. In this way, the logic controller can dynamically coordinate the activity of any variable components of the system. For example, in the event of a passed test after the previous user moves through the test exit gate in its open position, the logic controller may send signals to open the test entry gate to allow the next user to enter the testing area, close the test exit gate to prevent the next user from exiting the testing area, and reset the indication of the indicator.

In another embodiment of the safety check apparatus, the track comprises a moveable section that is displaceable between a first height and a second height, with the second height of the moveable track section being vertically lower than the first height of the moveable track section. The user's moveable member can be moved into this moveable track section and then a load may be introduced into the lanyard system including the connections between the harness and lanyard and the lanyard and moveable member by the user sitting down or leaning into the harness. If the lanyard system supports the load, the connection would pass the safety check and the user would be allowed to proceed forward, such as into a course track traversing the challenge course connected to the track of the safety check apparatus. If the lanyard system does not support the load (e.g., if the user's harness detached from the lanyard), the connection would fail the safety check and the user may then be refitted in the lanyard system and retested. As described above, a first gate or test entry gate located before the moveable track section may ensure only one user is being tested at a time. A second gate or test exit gate located after the moveable track section may ensure a user cannot proceed forward unless the test was successful. The gates may be provided in the tracking to block the path of the moveable member therethrough, for example. The gates could also physically block the path of the user, like in the manner of a turnstile or door.

The load introduced into the lanyard system causes the moveable member to act on the moveable track section with a downward force. If the lanyard system supports the load, the moveable track section will be vertically displaced downward from the first height to the second height. If the lanyard system does not support the load, the moveable track section will not be displaced. A sensor may be triggered when the moveable track section is displaced downward to the second height. This sensor may then subsequently send a signal to unlock the second gate, located after the moveable track section, or to a logic controller which would then send a signal to unlock the second gate, thereby allowing the user to pass through the safety check apparatus. The moveable track section sensor could be a proximity sensor, weight sensor, or any other suitable sensor for verifying that the moveable track section is loaded. To ensure that users are not pulling down on the lanyard with their arms to displace the moveable track section and trigger the sensor, or supporting the connection between the harness and the lanyard during the test by holding onto the same, additional sensors may be provided which users would have to trigger with their hands in some embodiments. For example, a sensor connected to a hand element may be located on either side of the moveable track section. To engage the hand elements and trigger these hand element sensors, a user may have to pull upwardly or downwardly on ropes, press buttons, actuate levers, or perform similar actions to ensure the user's hands are not on the lanyard system. In this configuration, the gate located after the moveable track section could be set up to remain locked until simultaneously receiving signals from the moveable track section sensor and both hand element sensors.

The moveable track section may have an integrated tensioner to ensure that the moveable track section resets from the second height to the first height after the safety check is completed. For example, the tensioner may comprise a spring, counterweight, or any other suitable method of lifting the moveable track section back to the first height. Additionally, one or more indicators could be incorporated into the system to notify users that they have passed the test and that the second gate has been unlocked, allowing them to proceed. For example, the indicator could be a visual light, audible sound, or combination thereof.

In one configuration of this embodiment, the track comprises a moveable track section and a moveable track section sensor. The moveable track section provides the second position of the track. The moveable track section is vertically displaceable, and upwardly biased by a biasing force provided by a tensioner. The moveable track section is downwardly displaceable when a load, provided by a user sitting down in the harness or leaning into the harness, is applied which overcomes the biasing force of the tensioner. The moveable track section sensor is configured to detect displacement of the moveable track section. An indicator is configured to visually indicate when the moveable track section sensor detects that the moveable track section has been displaced. In further embodiments, at least one hand element extends downward from the moveable track section, with each hand element being configured to be engaged by a user's hand. At least one hand element sensor is configured to detect when a user has engaged with the at least one hand element, and the indicator is configured to visually indicate when the at least hand element sensor detects that the at least one hand element has been engaged by a user. The track may also have a test entry gate configured to prevent a user from proceeding to the moveable track section until a previous user has completed testing, and/or a test exit gate configured to prevent a user from proceeding from the moveable track section to the course track until the user has completed testing. The safety check apparatus may further comprise a logic controller which processes signals received from the moveable track section sensor and/or the at least one hand element sensor, and controls operation of the indicator, the test entry gate, and/or the test exit gate based on said signals. The track may be inclined between the first position of the track and the second position of the track, with the track being vertically higher at the second position than at the first position.

For any of the embodiments described herein, the track may comprise a track access point for mounting or dismounting the moveable member with respect to the track, a course track ingress point for the moveable member to enter the course track from the safety check apparatus, and a course track egress point for the moveable member to enter the safety check apparatus from the course track, with the second position of the track being arranged along the track between the track access point and the course track ingress point. In some embodiments, the track further comprises a bypass track section extending between the course track ingress point and the course track egress point. The bypass track section may have a one-way gate configured to allow a user to move forward from the course track ingress point toward the course track egress point, but not from the course track egress point back toward the course track ingress point. In some embodiments, the track has a one-way gate configured to allow a user to move from the course track egress point toward the course track access point, but not from the course track access point back toward the course track egress point. For any of the embodiments described herein, the track may comprise a staging area track section for fitting and/or unfitting users with components of the lanyard system, or storing lanyard systems when not in use for ready access.

The safety check apparatus may also comprise various other aspects as described in more detail below. It should also be appreciated that certain aspects of the present disclosure may be used, and advantages thereof may be realized, separate from and independent of a track configuration requiring having may be practiced separately and independently

The present disclosure also provides a method for testing a lanyard system at an entrance to a challenge course, wherein a track is arranged at the entrance above a supporting surface. Preferably, the track is connected to a course track which traverses the challenge, such that the user with the lanyard system may move directly onto the course track after being tested. In some embodiments, the track of the safety check apparatus is integral with and transitions into a course track that traverses the challenge course. The method comprises the steps of:

coupling a connection point of a harness worn by a user to a connection point of a lanyard (e.g. via one or more carabiners), wherein the lanyard is attached to a moveable member which is secured to and displaceable relative to the track, the lanyard extends a length from the moveable member, and the track comprises a first position and a second position, the first position being a first vertical distance above the supporting surface, the second position being a second vertical distance above the supporting surface, and the first vertical distance is shorter than the second vertical distance;

loading at least a portion of the user's weight onto the harness at the second position of the track, whereby the user's weight is supported by components that attach the user to the track in the event of a passed test, and whereby the user's weight is transferred to the supporting surface in the event of a failed test (e.g. the user falls to the supporting surface);

in the event of a passed test, allowing the user to proceed from the track to the course track of the challenge course; and

in the event of a failed test, preventing the user from proceeding from the track to the course track.

The purpose of loading at least a portion of the user's weight onto the harness is to ensure that the lanyard system, or a specific connection thereof, is properly connected. Preferably, at least a majority of the user's weight is loaded onto the harness at the second position of the track. In some embodiments, at least 75% of the user's weight is loaded onto the harness. In further embodiments, at least 95% of the user's weight is loaded onto the harness. In still further embodiments, all the user's weight is loaded onto the harness. However, it should be appreciated that the amount of force introduced into the lanyard system during testing can be varied in different embodiments. For example, the load introduced into the lanyard system may be selected to correspond to the minimum force required to ensure the lanyard is coupled to the harness for a particular lanyard system. In some lanyard systems, the harness has a chest loop through which the lanyard is inserted before being coupled to the harness via one or more carabiners. In this case, the force needed to test whether the harness is coupled to the lanyard must be great enough to overcome a frictional force holding the lanyard in the chest loop of the harness. If the harness is not properly coupled to the lanyard via carabiners, the harness will separate from the lanyard when such a force is applied. This has been observed to occur with about 30 lbs. of force for certain lanyard systems. Depending on the particular design of the lanyard system and components thereof, however, a smaller force may be sufficient to pull apart the harness and the lanyard in other lanyard systems.

In the event of a failed test, the method may further comprise the step of checking the components that attach the user to the track, refitting one or more components that attach the user to the track as determined by said checking, and retesting until there is a passed test before allowing the user to proceed from the track to course track of the challenge course.

In some embodiments, the method further comprises opening a test entry gate along the track to allow the user with the moveable member to move into the second section of the track; closing the test entry gate after the user with the moveable member moves into the second section of track to prevent a subsequent user with another moveable member from entering the second section of the track while the user is undergoing testing; and in the event of a passed test, the opening the test entry gate to allow the subsequent user with another moveable member to enter the second section of the track for testing. Such test entry gates are described above in reference to the safety check apparatus.

In some embodiments, the method further comprises in the event of a failed test, keeping a test exit gate along the track closed to prevent the user with the moveable member from moving out of the second section of track until there the user has a passed test; and in the event of a passed test, opening the test exit gate to allow the user with the moveable to proceed to the course track of the challenge course, whereby the test exit gate is closed again once the user with the moveable member moves out of the second section of the track to prevent a subsequent user with another moveable member from bypassing testing. Such test exit gates are described above in reference to the safety check apparatus.

In some embodiments, the method further comprises changing the appearance of a visual indicator according to a testing status. Such indicators are described above in reference to the safety check apparatus.

In some embodiments, when the user's weight is loaded onto the harness, the connection point of the harness is positioned higher above the supporting surface at the second position of the track than at the first position of the track.

In some embodiments, the difference between the first vertical distance of the first position of the track and the second vertical distance of the second position of the track corresponds to the height that a user falls when the user steps or falls off an element of the challenge course before being caught by the lanyard, which is coupled to the harness and secured with respect to the course track traversing the challenge course via the moveable member.

In some embodiments, the first vertical distance of the first position of the track above the supporting surface is selected to make it easier for the user to reach the lanyard and move the moveable member connected to the lanyard along the track, at least compared to the second vertical distance of the second position of the track.

In some embodiments, the second vertical distance of the second position of the track above the supporting surface is selected to make it easier for the user to move from sitting in the harness to standing on the supporting surface, at least compared to the first vertical distance of the first position of the track.

Where it is anticipated that the user will stand on the supporting surface at the second position of the track, the method may further comprise the step of moving the lanyard with the moveable member attached into the second position of the track prior to coupling the harness to the lanyard, wherein the lanyard comprises a plurality of connection points, and the connection point of the harness is coupled to the first adjacent connection point of the lanyard which is below the connection point of the harness when the user wearing the harness is standing under the second position of the track and the length of the lanyard is pulled downward from the moveable member in the track above. In other embodiments where it is anticipated that the user will not stand on the supporting surface at the second position of the track, the second vertical distance, which extends between the supporting surface and the second position of the track, may be configured to prevent the user's feet from contacting the supporting surface when the user's weight is loaded onto the harness and the user is supported by components that attach the user to the track in the event of a passed test.

The method for testing a lanyard system at an entrance to a challenge course may be performed using one or more embodiments of a safety check apparatus described herein.

The following embodiments and aspects thereof are described and depicted in conjunction with systems, tool and methods which are meant to be illustrative, not limiting in scope. In various embodiments, one or more of the above described problems have been reduced or eliminated, while other embodiments are directed to other improvements.

### BRIEF DESCRIPTION OF THE DRAWINGS

The present disclosure is described hereafter based on illustrative embodiments with reference to the following figures:

FIG. 1 shows a perspective view of one possible embodiment of a multilevel challenge course;

FIG. 2 shows a side view of another possible embodiment of an elevated challenge course with a user therein;

FIG. 3 shows a user descending across an element of a challenge course between platforms of the challenge course;

FIG. 4 shows a lanyard system for attaching a user to a challenge course track;

FIG. 5 shows a first embodiment of a safety check apparatus provided at an entrance to a challenge course;

FIG. 6 shows another embodiment of a safety check apparatus provided at an entrance to a challenge course;

FIG. 7 shows another embodiment of a safety check apparatus provided at an entrance to a challenge course;

FIG. 8 shows another embodiment of a safety check apparatus provided at an entrance to a challenge course;

FIG. 9 shows another embodiment of a safety check apparatus provided at an entrance to a challenge course;

FIG. 10 shows another embodiment of a safety check apparatus provided at an entrance to a challenge course;

FIG. 11 shows a perspective view of a multilevel challenge course with another embodiment of a safety check apparatus;

FIG. 12 shows a detail view of box A in FIG. 11;

FIG. 13 shows a side view of the safety check apparatus of FIG. 12;

FIG. 14 shows a front view of the safety check apparatus of FIG. 12;

FIG. 15 shows a bottom view of the safety check apparatus of FIG. 12;

FIG. 16 shows another embodiment of a safety check apparatus in the view of FIG. 12;

FIG. 17 shows a side view of the safety check apparatus of FIG. 16;

FIG. 18 shows a front view of the safety check apparatus of FIG. 16; and

FIG. 19 shows a bottom view of the safety check apparatus of FIG. 16.

Before further explaining the depicted embodiments, it is to be understood that the invention is not limited in its application to the details of the particular arrangements shown, since the invention is capable of other embodiments. It is intended that the embodiments and figures disclosed herein are to be considered illustrative rather than limiting. Also, the terminology used herein is for the purposes of description and not limitation.

### DETAILED DESCRIPTION

Certain terminology is used in the following description for the purposes of clear and concise explanation, and should not be considered or construed as limiting. For example, terms such as “connected,” “attached,” “coupled,” or similar language includes both directly and indirectly “connected,” “attached,” and “coupled.” This convention not only applies to the terms specifically mentioned, but also to similar, related, and derivative terms and phrases as well. Further, the term “lanyard” is used herein as a term of convenience for purposes of description, but should be construed to include functional equivalents to lanyards, such as tethers, ropes, cords, cables and the like, or any other length of material or device that is capable of providing an attachment between a user and the challenge course as described below. This same principle applies to other terms used herein as well, such as “movable member,” “harness,” “carabiner” to only name a few.

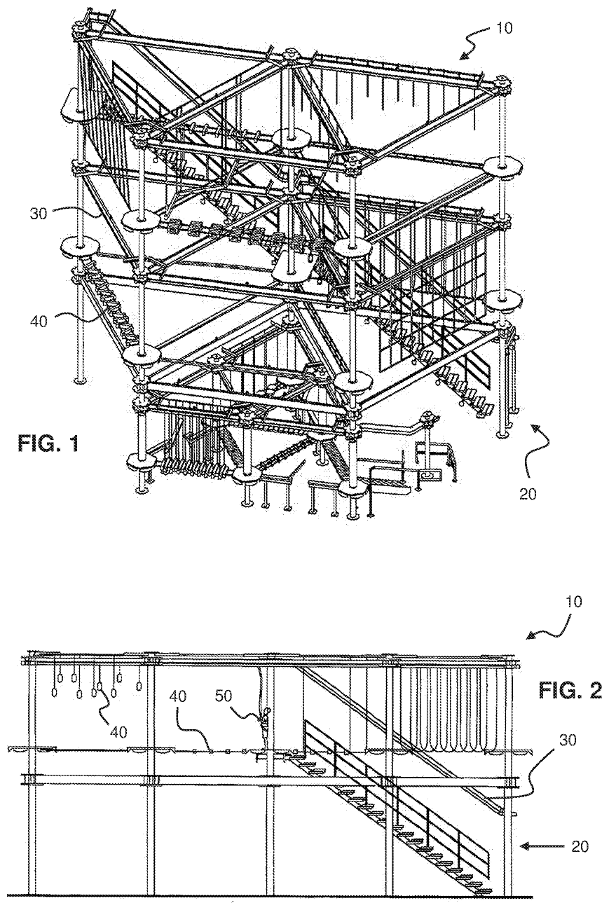

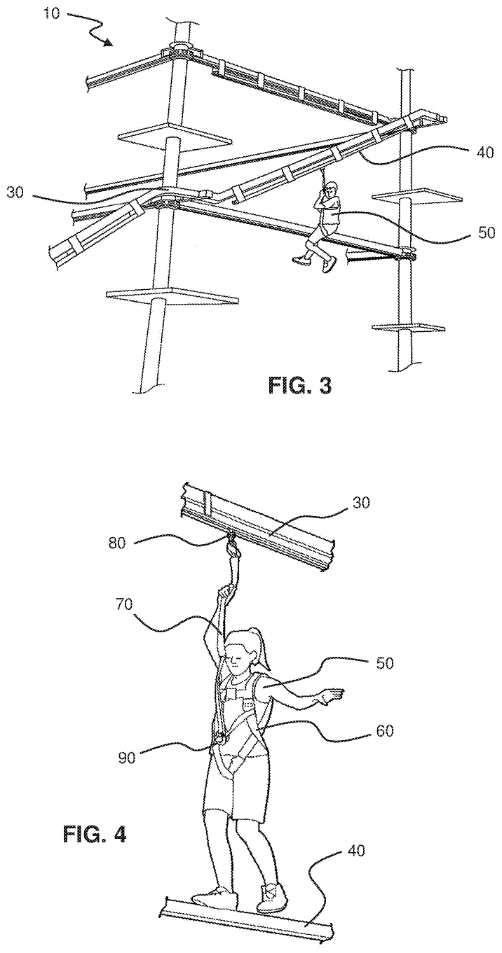

FIG. 1 shows one possible embodiment of a challenge course 10 having multiple levels, with the top tier positioned a considerable distance above ground level. FIG. 2 shows another embodiment of a challenge course 10 elevated above ground level. In each case, the challenge course 10 comprises a course entrance 20 on the ground level and a course track 30 running through the challenge course 10. Elements 40 are arranged within the challenge course 10 along the path of the course track 30, which form obstacles to be traversed by a user 50. The user 50 may be secured to the course track 30 for safety (described in more detail below with respect to FIG. 4) at the course entrance 20 before entering into the challenge course 10 and encountering elements 40. FIG. 3 shows another embodiment of a challenge course 10, wherein the course track 30 spans between adjacent course platforms having a non-horizontal slope or incline, and thereby forms a course element 40 that the user 50 may descend down via gravity. As illustrated by FIGS. 1-3, there is an inherent risk of injury or death if the attachment between the user 50 and the course track 30 fails and the user 50 is thus allowed to fall from height to the ground level.

FIG. 4 shows a lanyard system attachment between the user 50 and the track 30 of a challenge course. The user 50 wears a harness 60 that is connected to a lanyard 70. The lanyard 70 is securely connected to a moveable member 80 mounted within the track 30. The moveable member 80 is supported by the track 30 and displaceable along the track 30 as the user 50 moves through the challenge course 10, but otherwise is not able to exit the track 30 except by design at designated points (e.g., the course entrance 20). For example, the moveable member 80 may extend downward through a slot of the track 30 for attachment to the lanyard 70, and include a puck with a width wider than the track slot arranged above the track slot, such that the puck is displaceable along the track 30 but not downward through the track slot. Other designs of the moveable member 80 could also be used. A carabiner 90 or similar device may be used to couple a connection point of the harness 60 to a connection point of the lanyard 70. Here, the user 50 is traversing a course element 40 formed by a narrow beam. If the user 50 were to step off the element 40, the lanyard 70 which is anchored to the track 30 by the moveable member 80 will act to catch the user 50 via the connection between the lanyard 70 and the harness 60 worn by the user 50, and thereby prevent the user 50 from continuing to fall and potentially suffering serious injury. The length of the lanyard 70 between the moveable member 80 and the harness 60 is long enough to provide an adequate amount of freedom of motion for navigating course elements 40, but short enough to reduce the risk of entanglement and the distance the user 50 will fall before being caught by the lanyard system. In some embodiments, the lanyard 70 may have a plurality of connection points along its length for coupling to the harness 60. An example of such a lanyard is described in U.S. Patent Application Publication No. 2019/0134438 A1 published May 9, 2019 (“Liggett et al.”). The plurality of connections points allows users 50 of varying heights to use the same lanyard 70 to achieve the desired amount of slack by attaching the harness 60 to an appropriate connection point of the lanyard 70. Therefore, the lanyard 70 is slack when the user 50 is standing on the element 40 and taut when the user 50 is suspended by the lanyard system. However, if any of the connection points between the track 30, moveable member 80, lanyard 70 and harness 60 are not properly engaged and secured, a catastrophic failure of the lanyard system could potentially occur meaning the user would not actually be supported and thus not prevented from falling.

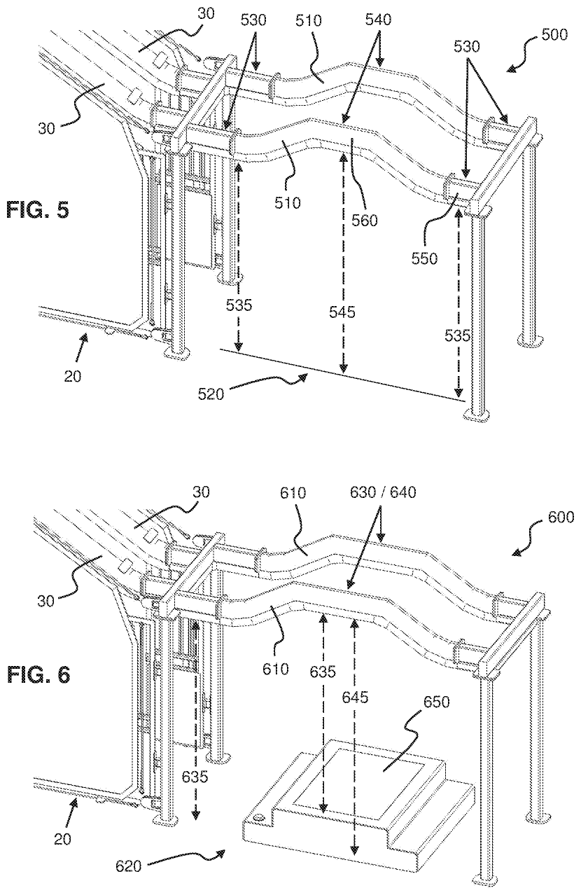

Therefore, a safety check apparatus according to the present disclosure may be provided to reduce the likelihood of lanyard system attachment issues going undetected. As shown in the embodiments of FIGS. 5-10, the safety check apparatus 500, 600, 700, 800, 900, 1000 may be arranged at the entrance 20 to a challenge course 10 (see FIGS. 1 and 2 for illustrative examples of challenge courses). The safety check apparatus 500 600, 700, 800, 900, 1000 comprises a track 510, 610, 710, 810, 910, 1010 arranged above a supporting surface 520, 620, 720, 820, 920, 1020 which is generally indicated by imaginary line 520 in FIG. 5 for purposes of illustration. The term “supporting surface” refers to any surface that acts to support a person using the safety check apparatus 500, 600, 700, 800, 900, 1000. For example, the supporting surface 520, 620, 720, 820, 920, 1020 may be provided by the natural ground or a man-made floor, as well as other components such as platforms, stands, stools, steps, stairs, ramps, walkways, obstacles, padding, mats and the like. Accordingly, although not specifically included or identified in all of the drawings, it should be understood that each one of the depicted embodiments necessarily includes a supporting surface underneath at least part of the track 510, 610, 710, 810, 910, 1010. Further, although not shown in FIGS. 5-10, it should be understood that the user 50 may be attached to the track 510, 610, 710, 810, 910, 1010 in the same manner described above with respect to lanyard system of FIG. 4. Of course, other user attachment configurations may be used as well within the scope and spirit of the present disclosure.

The track 510, 610, 710, 810, 910, 1010 comprises at least a first position 530, 630, 730, 830, 930, 1030 and a second position 540, 640, 740, 840, 940, 1040. The first position 530, 630, 730, 830, 930, 1030 of the track 510, 610, 710, 810, 910, 1010 is provided at a first vertical distance 535, 635, 735, 835, 935, 1035 above the supporting surface 520, 620, 720, 820, 920, 1020. The second position 540, 640, 740, 840, 940, 1040 of the track 510, 610, 710, 810, 910, 1010 is provided at a second vertical distance 545, 645, 745, 845, 945, 1045 above the supporting surface 520, 620, 720, 820, 920, 1020. The first vertical distance 535, 635, 735, 835, 935, 1035 of the first position 530, 630, 730, 830, 930, 1030 is shorter than the second vertical distance 545, 645, 745, 845, 945, 1045 of the second position 540, 640, 740, 840, 940, 1040. Both vertical distances 535, 635, 735, 835, 935, 1035 and 545, 645, 745, 845, 945, 1045 are longer than the length of the lanyard 70 (see FIG. 4 and accompanying text).

In the first position 530, 630, 730, 830, 930, 1030 of the track 510, 610, 710, 810, 910, 1010, the user 50 may stand on, walk on, or otherwise be supported by the supporting surface 520, 620, 720, 820, 920, 1020. Therefore, the length of lanyard 70 is slack when the lanyard 70 is attached to a user 50 at the first position 530, 630, 730, 830, 930, 1030. The first vertical distance 535, 635, 735, 835, 935, 1035 may correspond to the vertical distance between the user 50 and the course track 30 throughout rest of the challenge course 10, whereby the length of the lanyard 70 between the moveable member 80 and the connection point of the lanyard 70 to the harness 60 is long enough to provide an adequate amount of freedom of motion for navigating course elements 40, but short enough to reduce the risk of entanglement and the distance the user 50 will fall before being caught by the lanyard system.

In the second position 540, 640, 740, 840, 940, 1040 of the track 510, 610, 710, 810, 910, 1010, the user 50 may or may not be able to stand on, walk on, or otherwise be supported by the supporting surface 520, 620, 720, 820, 920, 1020 depending on the particular embodiment. Regardless, however, the lanyard 70 is configured to be taut when the user 50 sits or leans into, or his lifted up by, his or her harness 60 at the second position 540, 640, 740, 840, 940, 1040. At the second position 540, 640, 740, 840, 940, 1040, at least a portion of the weight of the user 50 is transferred to the harness 60, lanyard 70, moveable member 80, and any connection pieces therefor (the lanyard system), and thereby the track 510, 610, 710, 810, 910, 1010 above; it being appreciated that all the weight of the user 50 may not necessarily be transferred to the lanyard system, in absolute terms, here if one or more feet of the user 50 remain touching and thus partially supported by the supporting surface 520, 620, 720, 820, 920, 1020 after the user's weight is loaded into the harness 60. Therefore, if the lanyard system is properly connected and functioning, the user 50 will be completely or partially supported by the lanyard system. If completely supported, the user 50 will be suspended by the lanyard system. However, the user 50 will otherwise be supported by the supporting surface 520, 620, 720, 820, 920, 1020 if the lanyard system fails at the second position 540, 640, 740, 840, 940, 1040 when the user's weight is loaded into the harness 60 (catastrophic failure). For example, the user may fall or otherwise descend to the supporting surface 520, 620, 720, 820, 920, 1020, particularly in embodiments where the second vertical distance 545, 645, 745, 845, 945, 1045 is configured to prevent the user's feet from contacting the supporting surface 520, 620, 720, 820, 920, 1020 during testing. In this way, the safety check apparatus 500, 600, 700, 800, 900, 1000 may be used to check whether the user 50 is safely attached to the track 510, 610, 710, 810, 910, 1010. However, the second vertical distance 545, 645, 745, 845, 945, 1045 should not be significantly larger than necessary to elevate all of the weight of the user 50 from the supporting surface 520, 620, 720, 820, 920, 1020, in order to reduce the falling distance and corresponding risk of injury in the event the lanyard system experiences a catastrophic failure at the second position 540, 640, 740, 840, 940, 1040 of the track 510, 610, 710, 810, 910, 1010.

It should be appreciated that it may also be possible for the user 50 to sit down into the harness 60 at the first position 530, 630, 730, 830, 930, 1030 of the track 510, 610, 710, 810, 910, 1010, such that the lanyard system would bear the full or substantially the full weight of the user 50 at that location, thereby checking the safety of the attachment. However, since the first vertical distance 535, 635, 735, 835, 935, 1035 is smaller than the second vertical distance 545, 645, 745, 845, 945, 1045 both being larger than the length of the lanyard 70 the user 50 would need to sit down into the harness 60 vertically lower along first vertical distance 535, 635, 735, 835, 935, 1035 as compared to the second vertical distance 545, 645, 745, 845, 945, 1045 before being suspended by the lanyard system. This then makes it relatively harder for the user 50 to stand back up under his or her own strength at the first position 530, 630, 730, 830, 930, 1030 as compared to the second position 540, 640, 740, 840, 940, 1040 of the track 510, 610, 710, 810, 910, 1010. For this reason, the safety check apparatus 500, 600, 700, 800, 900, 1000 includes the second position 540, 640, 740, 840, 940, 1040 instead of only the first position 530, 630, 730, 830, 930, 1030 by itself. In this way, the safety check apparatus 500, 600, 700, 800, 900, 1000 can approximate a user-fall scenario in a safe and controlled setting.

Turning now to individual embodiments, FIG. 5 shows a first possible embodiment of a safety check apparatus 500. Here, the track 510 is inclined between a first portion 550 and a second portion 560 of the track 510. The second portion 560 is vertically higher than the first portion 550 with respect to the supporting surface 520. The first position 530 of the track 510 is located in the first portion 550, and the second position 540 of the track 510 is located in the second portion 560. The track 510 is connected to and transitions into the course track 30 of the challenge course 10. The track 510 may also be integral with the course track 30. In the depicted embodiment, the second portion 560 of track 510 is arranged between two first portions 550 of the track 510, with one first portion 550 positioned between the course track 30 and the second portion 560, and the other first portion 550 providing access to the track 510. In other embodiments, the second portion 560 of the track 510 may be arranged between the course track 30 and a single first portion 550 of the track 510. In other embodiments, a single first portion 550 of the track 510 may be arranged between the course track 30 and the second portion 560 of the track 510.

FIG. 6 shows another possible embodiment of a safety check apparatus 600. Here, the supporting surface 620 comprises a platform 650 arranged underneath the track 610. The platform 650 is displaceable between a first height and a second height, with the first height of the platform 650 being vertically higher than the second height of the platform 600. In the drawing, the platform 650 is in the first height configuration. The first position 630 of the track 610 is be located above the adjustable platform 650 when the platform 650 is at the first height. The second position 630 of the track 610 is located above the adjustable platform 650 when the platform 650 is at the second height (not shown). Therefore, the difference between the first height and the second height of the platform 650 corresponds to the difference between the first vertical distance 635 and the second vertical distance 645 of the first position 630 and the second position 640, respectively, with the platform 650 providing the supporting surface 620 thereunder. Accordingly, the first and second positions 630, 640 may correspond to the same location on the track 610, with the first vertical distance 635 defined by the platform 650 when raised to the first height and the second vertical distance 645 defined by the platform 650 when lowered to the second height. The platform 650 may be actuated between the first height and the second height by a hydraulic lift, a traction lift, or any other suitable mechanism for moving the platform 650 up and down. It should be appreciated that although the track 610 is depicted having an incline as in the previous embodiment, but the track 610 may alternatively be horizontally level, for example, if the first height of the platform 650 was flush with the adjacent supporting surface 620 and the second height of the platform 650 was recessed relative to the remainder of the supporting surface 620 (e.g., if the platform was installed beneath ground level). In some embodiments, the second vertical distance 645, which extends between the track 610 and the platform 650 when the platform 650 is positioned at the second height, is configured to prevent a user's feet from contacting the platform 650 when the platform 650 is lowered to the second height,

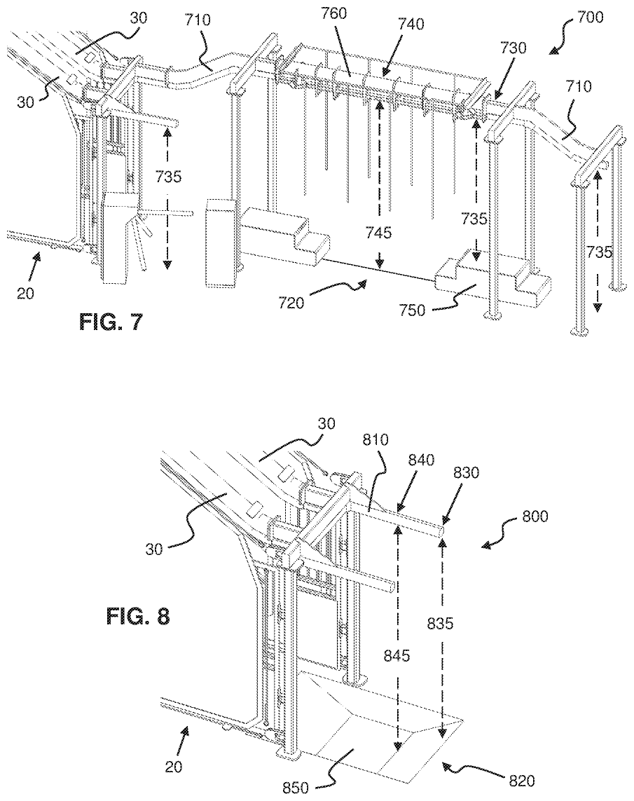

FIG. 7 shows another possible embodiment of a safety check apparatus 700. Here, the supporting surface 720 comprises an elevated platform 750 underneath the track 710. The track 710 comprises a rail portion 760 arranged above the supporting surface 720 horizontally adjacent to the platform 750. The moveable member 80 comprises one or more wheels configured to roll along the rail portion 760 of the track 710 (not shown). An example of such a moveable member system is described in U.S. Patent Application Publication No. 2017/0036123 A1 published Feb. 9, 2017 (“Liggett et al.”). The first position 730 of the track 710 is located above the elevated platform 750. The second position 740 of the track 710 is located in the rail portion 760 of the track 710. The rail portion 760 may further comprise elements 770 to assist the user 50 in traversing the rail portion 760, particularly if the rail portion 760 is not sloped and the user 50 is unable to stand on the supporting surface 720 through the rail portion 760, such as where the second vertical distance 745, which extends between the supporting surface 720 and the rail portion 760 of the track 710, is configured to prevent a user's feet from contacting the supporting surface 720 when a user 50 rolls along the rail portion 760 of the track 710. For example, elements 770 could be ropes or other hanging objects for the user 50 to grab to pull himself or herself forward across the rail portion 760. The track 710 is connected to and transitions into the course track 30 of the challenge course 10. The track 510 may also be integral with the course track 30. In the depicted embodiment, the second portion 740 of track 710 is arranged between two first positions 730 of the track 710, with one first position 730 positioned between the course track 30 and the second position 740, and the other first position 730 providing access to the track 710. In other embodiments, the second position 740 of the track 710 may be arranged between the course track 30 and a single first position 730 of the track 710. In other embodiments, a single first position 730 of the track 710 may be arranged between the course track 30 and the second position 740 of the track 710. In a modification of this embodiment (not shown), the supporting surface 720 comprises a vertical dip or depression along the rail portion 760 of the track 710 similar to the embodiment of FIG. 8. Therefore, the first position 730 and the second position 740 of the track 710 may share the same or substantially the same vertical position, with the first position 730 of the track 710 being located above the supporting surface 720 horizontally adjacent to the vertical dip. With this modification, the elevated platform 750 may be omitted entirely.

FIG. 8 shows another possible embodiment of a safety check apparatus 800. Here, the supporting surface 820 comprises a vertical dip or depression 850. The second position 840 of the track 810 is located above the vertical dip 850 of the supporting surface 820. The first position 830 of the track 810 is located above the supporting surface 820 horizontally adjacent to the vertical dip 850. The track 810 is connected to and transitions into the course track 30 of the challenge course 10. The track 510 may also be integral with the course track 30. In the depicted embodiment, the second position 840 of the track 810 is arranged between the course track 30 and the first position 830 of the track 810. In other embodiments, the first position 830 of the track 810 may alternatively be arranged between the course track 30 and the second position 840 of the track 810.

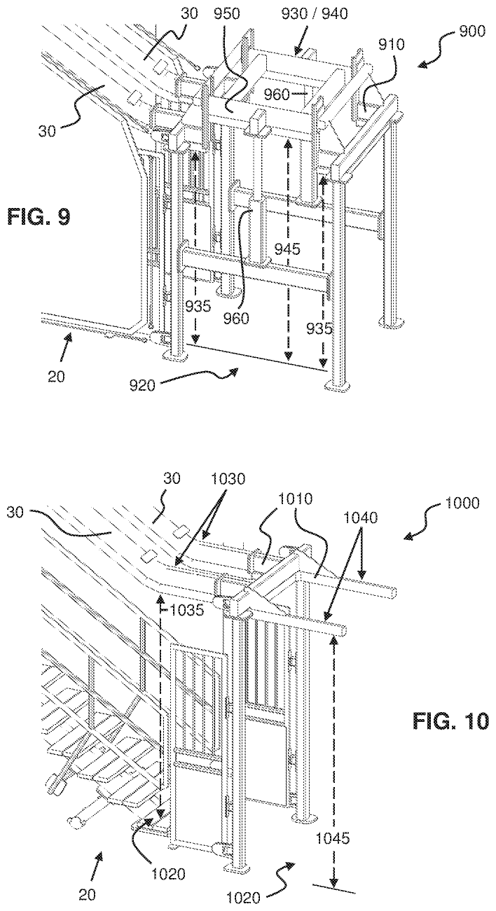

FIG. 9 shows another possible embodiment of a safety check apparatus 900. Here, the track 910 comprises a moveable portion 950 that is displaceable between a first height and a second height, with the second height of the moveable portion 950 being vertically higher than the first height of the moveable portion 950. In the drawing, the moveable portion 950 of the track 910 is in the second height configuration. The moveable portion 950 provides the first position 930 of the track 910 when the moveable portion 950 is at the first height (not shown). The moveable portion 950 provides the second position 940 of the track 910 when the moveable portion 950 is at the second height. Therefore, the difference between the first height and the second height of the moveable portion 950 corresponds to the difference between the first vertical distance 935 and the second vertical distance 945 of the first position 930 and the second position 940, respectively. Accordingly, the first and second positions 930, 940 correspond to the same location on the track 910, with the first vertical distance 935 defined by the moveable portion 950 when lowered to the first height, and the second vertical distance 945 defined by the moveable portion 950 when raised to the second height. The moveable portion 950 may be actuated between the first height and the second height by a hydraulic lift or hoist, a traction lift or hoist, or any other suitable mechanism for moving the moveable portion 950 up and down (as indicated by the lift mechanism 960 in FIG. 9). In the depicted embodiment, the track 910 is connected to and transitions into the course track 30 of the challenge course 10. The track 910 may also be integral with the course track 30. The moveable portion 950 of the track 910 is aligned with the course track 30 when the moveable portion 950 is positioned at the first height. In this configuration, the user 50 with his or her lanyard system can directly move between the track 910 and the course track 30 at the first height. In some embodiments, the second vertical distance 945, which extends between the supporting surface 920 and the moveable portion 950 of the track 910 when the moveable portion 950 of the track 910 is positioned at the second height, is configured to prevent a user's feet from contacting the supporting surface 920 when the moveable portion 950 of the track 910 is raised to the second height.

FIG. 10 shows another possible embodiment of a safety check apparatus 1000. Here, the track 1010 is connected to and transitions into the course track 30 of the challenge course 10, with the safety check apparatus 1000 functionally extending into the course entrance 20 forming part of the challenge course 10, as compared to the previous embodiments. The track 1010 may also be integral with the course track 30. The first position 1030 of the track 1010 is arranged between the course track 30 and the second position 1040 of the track 1010. The supporting surface 1020 underneath the first position 1030 of the track 1010 may be provided by a structure of the challenge course 10. In the depicted embodiment, for example, the supporting surface 1020 underneath the first position 1030 is provided by stairs of the course entrance 20 to the challenge course 10, although other structures such as ramps, walkways, platforms, obstacles and the like could also form the supporting surface 1020 at this location.

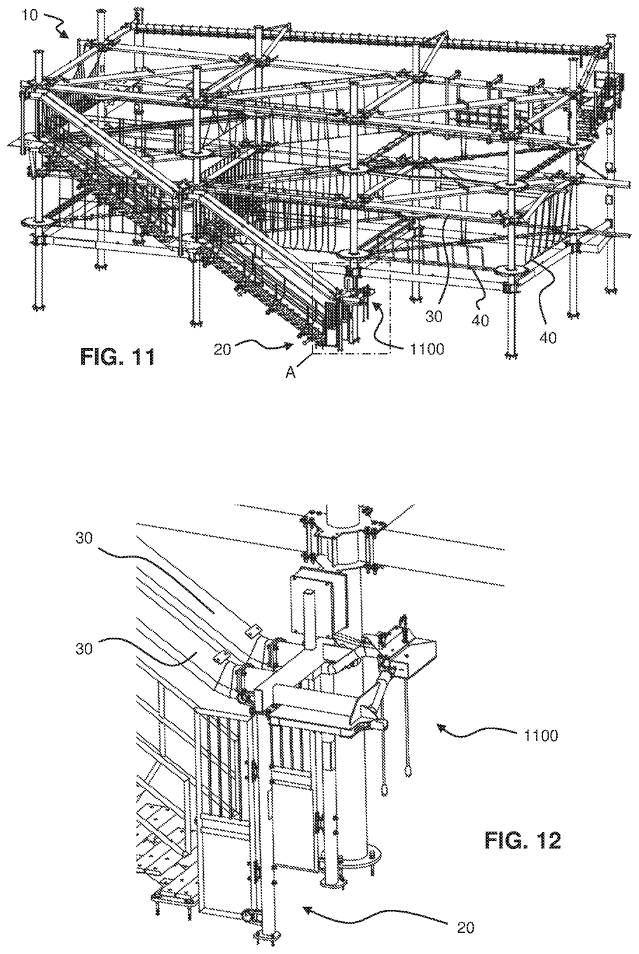

FIGS. 11 through 15 show another embodiment of a safety check apparatus 1100 according to the present disclosure. The safety check apparatus 1100 is provided at an entrance 20 to the challenge course 10. A course track 30 traverses elements 40 through the challenge course 10. The safety check apparatus 1100 comprises a track 1110 arranged above a supporting surface 1105. The term “supporting surface” can refer to any surface that acts to support a person moving within the safety check apparatus 1100. For example, the supporting surface 1105 may be provided by the natural ground, a man-made floor, or other structures. Although not shown in FIGS. 11-15, it should be appreciated that the user 50 may be attached to the track 1110 in the same manner described above with respect to lanyard system of HG. 4. For example, the user 50 may wear a harness 60 connected to lanyard 70 which is securely attached to a moveable member 80 mounted in the track 1110. Of course, other user attachment configurations may be used as well within the scope and spirit of the present disclosure.

The track 1110 includes a moveable track section 1115. The moveable track section 1115 is displaceable between a first height and a second height, wherein the second height of the moveable track section 1115 is vertically lower than the first height of the moveable track section 1115. The moveable member 80 mounted in the track 1110 can be slid into the moveable track section 1115, and then a load may be introduced into the lanyard system including the connections between the harness 60 and lanyard 70 and the lanyard 70 and moveable member by the user 50 sitting down or leaning into the harness 60. If the lanyard system supports the load, the connection would pass the safety check and the user 50 would be allowed to proceed forward, such as into the course track 30 traversing the challenge course 10, which is connected to the track 1110 of the safety check apparatus 1100. If the lanyard system does not support the load (e.g., if the user's harness 60 detached from the lanyard 70), the connection would fail the safety check and the user 50 may then be refitted in the lanyard system and retested.

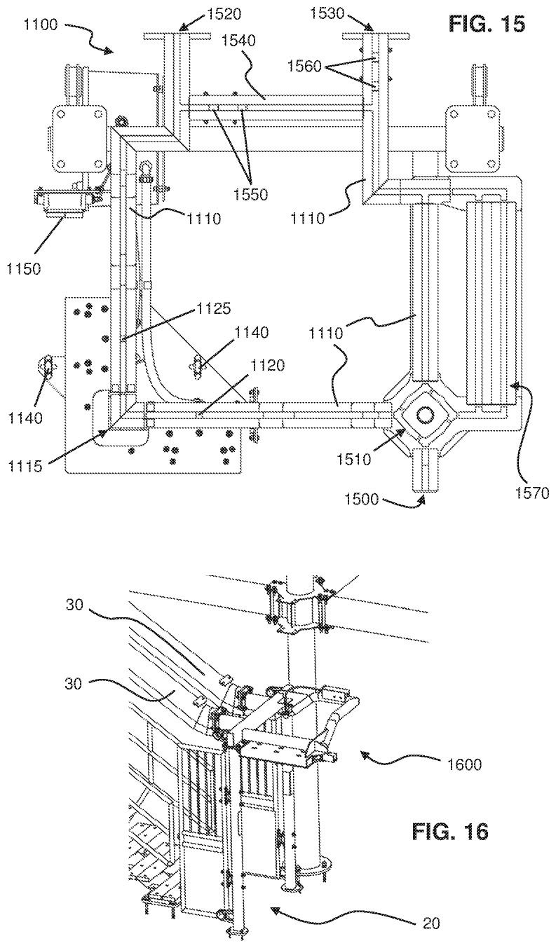

A test entry gate 1120 located before the moveable track section 1115 may ensure only one user is being tested at a time. For example, the gate 1120 may not open to allow a user 50 to enter the moveable track section 1115 until the previous user has completed the safety check and exited the moveable track section 1115. A test exit gate 1125 located after the moveable track section 1115 may ensure a user cannot proceed forward unless the test was successful. The gates 1120, 1125 may be provided in the tracking 1110 to block the path of the moveable member 80 therethrough (see FIG. 15). The gates 1120, 1125 could also physically block the path of the user, like in the manner of a turnstile or door.

The load, provided by the user sitting down or leaning into the harness 60, introduced into the lanyard system causes the moveable member 80 to act on the moveable track section 1115 with a downward force. If the lanyard system supports the load, the moveable track section 1115 will be vertically displaced downward from the first height to the second height. This results in a passed safety check test. If the lanyard system does not support the load, the moveable track section 1115 will not be displaced and the applied load will otherwise be transferred to the supporting surface 1120, such as by the user 50 falling to the ground. This results in a failed safety check test. A moveable track section sensor 1130 may be configured to monitor and detect when the moveable track section 1115 is displaced downward to the second height. The sensor 1130 may then subsequently send a signal to unlock the test exit gate 1125, located after the moveable track section 1115, or to a logic controller 1155 which would then send a signal to unlock the test exit gate 1125, thereby allowing the user 50 to continue through the safety check apparatus 1100. The moveable track sensor 1130 could be a proximity sensor, weight sensor, or any other suitable sensor for verifying that the moveable track section 1115 is loaded. The difference between the first height and the second height of the moveable track section 1115 may be selected based on the sensitivity and accuracy of the moveable track sensor 1130 (e.g., the moveable track section 1115 could only need to be displaced about 1 cm or less depending on the quality of the sensor 1130).

To ensure that users are not pulling down on the lanyard 70 with their arms to displace the moveable track section 1115 and trigger the sensor 1130, or supporting the connection between the harness 60 and the lanyard 70 during the test by holding onto the same, additional sensors 1135 may be provided which users would have to trigger through the use of their hands. For example, at least one hand element 1140 may be located on either side of the moveable track section 1115, with at least one hand element sensor 1135 configured to monitor and detect when each hand element 1140 has been engaged by the user 50. To engage the hand elements 1140 and trigger these sensors 1135, a user 50 may have to pull upwardly or downwardly on ropes, press buttons, actuate levers, or perform similar actions to ensure the user's hands are not on the lanyard 70. In the depicted embodiment, the hand elements 1140 are provided by ropes. With this system, the gate 1125 located after the moveable track section 1115 could be set up to remain locked until simultaneously receiving signals (directly or indirectly) from the moveable track sensor 1130 and both hand element sensors 1135. Like the moveable track sensor 1130, the hand element sensors 1135 could be proximity sensors, weight sensors, or any other suitable type of sensor for verifying that the hand elements 1140 have been loaded. In the case of disabled or amputee users, facility personnel may be able to unlock the test exit gate 1125, override the hand element sensors 1135, or otherwise assist in activating the hand elements 1140 to trigger the sensors 1135.

The safety check apparatus 1100 may have a tensioner 1145 to ensure that the moveable track section 1115 resets from the second height to the first height after the safety check is completed. For example, the tensioner 1145 may comprise a spring, counterweight, or any other suitable method of lifting the moveable track section 1115 back to the first height. In some embodiments, the sensor 1130 may detect displacement of the tensioner 1145 as a proxy for displacement of the moveable track section 1115, rather than detect displacement of the moveable track section 1115 directly. The tensioner 1145 may be configured to bias the moveable track section 1115 at the first height until the biasing force of the tensioner 1145 is overcome by the load introduced into the lanyard system by the user 50. In this way, the safety check test will fail by default to reduce the risk of false positives. In some embodiments, the biasing force of the tensioner 1145 could be set to filter out users (e.g., if the challenge course is not intended for young children, the biasing force could be set to 60 lbs or any other appropriate value depending on the challenge course). The biasing force could also be set to correspond to the minimum force required to ensure the lanyard 70 is coupled to the harness 60 for a particular lanyard system. For example, in some lanyard systems, the harness 60 has a chest loop through which the lanyard 70 is inserted before being coupled to the harness 70 via one or more carabiners 90. In this case, the force needed to test whether the harness 70 is coupled to the lanyard 60 must be great enough to overcome a frictional force holding the lanyard 60 in the chest loop of the harness 70. If the harness 70 is not properly coupled to the lanyard 60 via a carabiner 90, the harness 70 will separate from the lanyard 60 when such a force is applied. This has been observed to occur with about 30 lbs. of force for certain lanyard systems, but may be less depending on the specific design of the lanyard system.

Additionally, one or more indicators 1150 could be incorporated into the system to notify users that they have passed the test and that the test exit gate 1125 has been unlocked, thereby allowing them to proceed forward. For example, the indicator 1150 could utilize visual indication, audible indication, or combination thereof. In the depicted embodiment, the indicator 1150 emits visual light. The light may change from red to green, for example, to communicate that the user may move forward out of the test area. The safety check apparatus 1100 may further comprise a logic controller 1155 (shown with electrical box housing) which receives input signals from the sensors 1130, 1135 and transmits output signals to the gates 1120, 1125 and indicator 1150 to coordinate operation of the system.

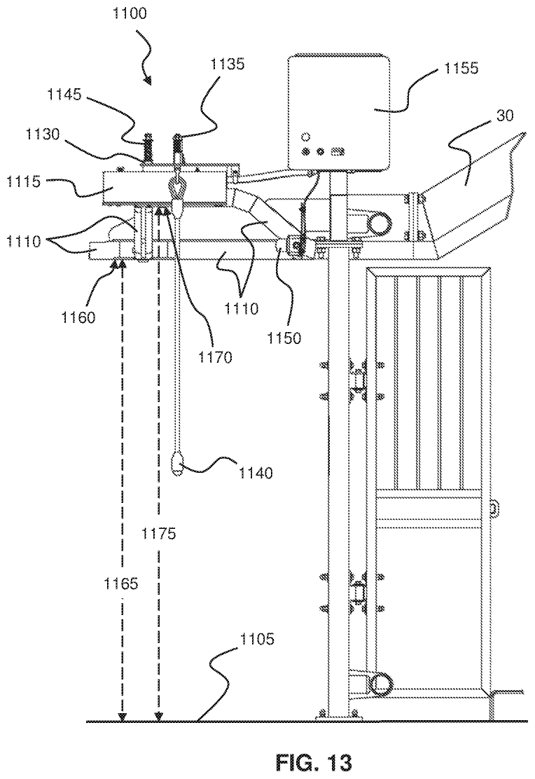

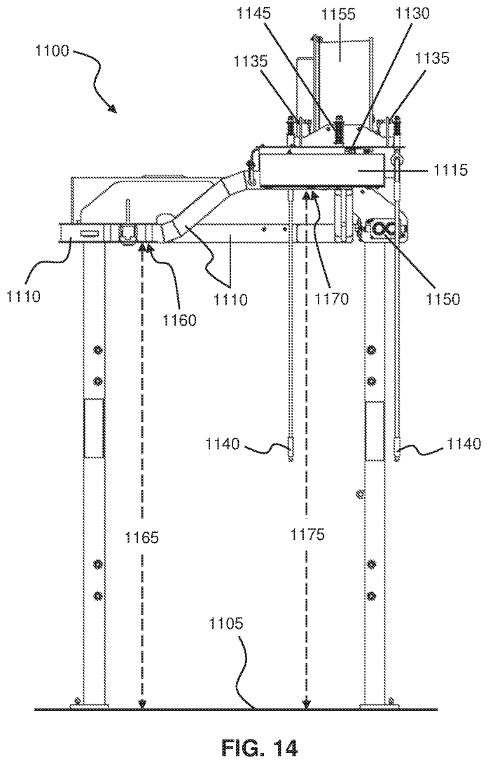

In the depicted safety check apparatus 1100, the track 1110 has a first position 1160 and a second position 1170 (see FIGS. 13 and 14). The second position 1170 is located in the moveable track section 1115. The first position 1160 of the track 1110 is provided at a first vertical distance 1165 above the supporting surface 1105. The second position 1170 is provided at a second vertical distance 1175 above the supporting surface 1105. Since the first vertical distance 1165 is shorter than the second vertical distance 1175 both being longer than the length of the lanyard 70 the user 50 would need to sit down into the harness 60 vertically lower along the first vertical distance 1160 (as compared to the second vertical distance 1170) before being suspended by the lanyard system. This then makes it relatively harder for the user 50 to stand back up under his or her own strength at the first position 1160 than the second position 1170 of the track 1110 if supported by the lanyard system. In this way, the increased height of the track 1110 in the test section (movable track section 1115) can assist the user 50 in standing up without assistance after performing the safety check.

Accordingly, in the embodiment of FIGS. 11-15, the track 1110 comprises a moveable track section 1115 and a moveable track section sensor 1130. The moveable track section 1115 provides the second position of the track 1170. The moveable track section 1115 is vertically displaceable, and upwardly biased by a biasing force provided by a tensioner 1145. The moveable track section 1115 is downwardly displaceable when a load, provided by a user 50 sitting down in the harness 70 or leaning into the harness 70, is applied which overcomes the biasing force of the tensioner 1145. The moveable track section sensor 1130 is configured to detect displacement of the moveable track section 1115. An indicator 1150 is configured to visually indicate when the moveable track section sensor 1130 detects that the moveable track section 1115 has been displaced. At least one hand element 1140 extends downward from the moveable track section 1115, with each hand element 1140 being configured to be engaged by a user's hand. At least one hand element sensor 1135 is configured to detect when a user 50 has engaged with the at least one hand element 1140, and the indicator 1150 is configured to also visually indicate when the at least hand element sensor 1135 detects that the at least one hand element 1140 has been engaged by a user 50. The track also has a test entry gate 1120 configured to prevent a user 50 from proceeding to the moveable track section 1115 until a previous user has completed testing, and/or a test exit gate 1125 configured to prevent a user 50 from proceeding from the moveable track section 1115 to the course track 30 until the user 50 has completed testing. The safety check apparatus 1100 further comprises a logic controller 1155 which processes signals received from the moveable track section sensor 1130 and/or the at least one hand element sensor 1135, and controls operation of the indicator 1150, the test entry gate 1120, and/or the test exit gate 1125 based on said signals. The track 1110 is inclined between the first position 1160 and the second position 1170 of the track 1110, with the track 1110 being vertically higher at the second position 1170 than at the first position 1160.

However, it should be appreciated that the safety check apparatus 1100 need not necessarily have a first and second track position 1160, 1170 with different vertical distances 1165, 1175 to practice certain aspects, and achieve advantages therefrom, of the safety check apparatus described in reference to this embodiment. The track 1110 of the safety check apparatus 1100 could instead be level or substantially level across the moveable track section 1115 (at the first height) and adjacent portions of the track 1110, while incorporating aspects such as moveable track sections 1115, test entry gates 1120, test exit gates 1125, moveable track section sensors 1130, hand element sensors 1135, hand elements 1140, tensioners 1145, indicators 1150, and/or logic controllers 1155. Additionally, although described in reference to this particular embodiment, one or more of these aspects may also be used with any of the other embodiments described herein.

As seen in the bottom view of FIG. 15, the safety check apparatus 1100 comprises further aspects to guide users in the right direction and prevent movement in others. The track 1110 has an access point 1500 to allow moveable members 80 to enter and exit the tracking of the safety check apparatus 1100. A track intersection 1510 provides multiple pathways to and from the access point 1500. One pathway from the track intersection 1510 is directed to the testing area, where the user 50 may pass through the test entry gate 1120 into the moveable track section 1115 to perform the safety check and, if successful, then pass through the test exit gate 1125. After the test exit gate 1125, the user 50 can continue along the track 1110 of the safety check apparatus 1100 and enter the course track 30 of the challenge course 10, the track 1110 being connected to the course track 30 at an ingress point 1520. The ingress point 1520 is intended to be used by users to enter the challenge course 10. The track 1110 is also connected to another course track 30 of the challenge course 10 at an egress point 1530. The egress point 1530 is intended to be used by users to exit the challenge course 10. In this way, user movement at the course entrance 20 may be controlled to reduce user traffic congestion. Near the course track ingress and egress points 1520, 1530, the track 1110 has a bypass track section 1540 extending therebetween. On the ingress point side, the bypass track section 1540 is arranged between the test exit gate 1125 and the ingress point 1520. Users who have not yet entered the challenge course 10 may use the bypass track section 1540 to avoid entering the challenge course 10 (e.g., in the case of an emergency, inclement weather. etc.). Users trying to exit the challenge course 10 who have followed the ingress course track 30 back to the ingress point 1520 may use the bypass track section 1540 to avoid proceeding through the safety check again.

Additionally, one or more bypass track one-way gates 1550 allow users to move from the ingress point side to the egress point side of the bypass track section 1540, but not vice versa. Likewise, one or more egress track one-way gates 1560 allow users to move along the track 1110 from the course track egress point 1530 toward the track access point 1500, but not vice versa. In this way, the one-way gate 1560 prevents users from bypassing the safety check test by using the course track egress point 1530 to enter the challenge course 10. After passing through the course track egress point 1530 or the bypass track section 1540, and the corresponding gates 1550, 1560, the user 50 may then proceed along the track 1110 to exit via the access point 1500. As previously described in reference to the test entry and exit gates 1120, 1125, the gates 1550, 1560 may be provided in the overhead tracking to block the path of the moveable member 80 therethrough. The gates 1550, 1560 could also physically block the path of the user 50, like in the manner of a turnstile or door. In some embodiments, the track 1110 may comprise one or more staging area track sections 1570 for users to be fitted with and/or unfitted from the lanyard system. Lanyard systems not currently in use may also be stored in the staging area track section 1570 for ready access when needed. The staging area track section 1570 may be arranged off a pathway of the track intersection 1510 to avoid user traffic congestion, such that the staging area track section 1570 does not impede pathways between the track access point 1500 and the course track ingress or egress points 1520, 1530.

Although described in reference to the embodiment of FIG. 15, one or more of the aforementioned aspects may also be used with any of the other embodiments described herein.

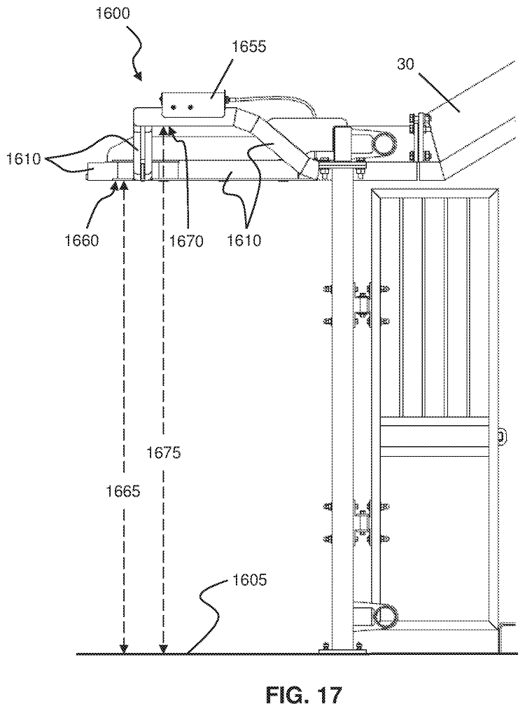

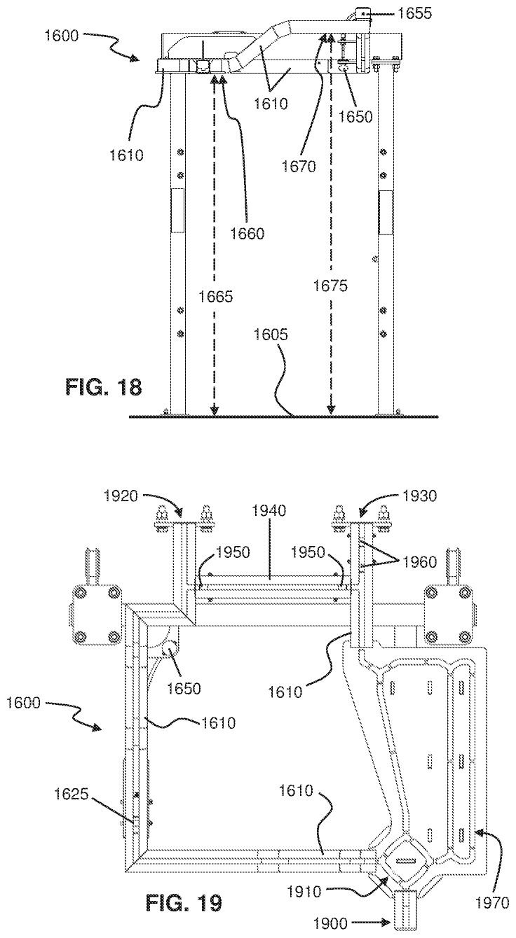

FIGS. 16 through 19 show another embodiment of a safety check apparatus 1600 according to the present disclosure. The safety check apparatus 1600 is similar to the safety check apparatus 1100, but does not include a moveable track section 1115 or hand elements 1140, or the corresponding components therefor, such as a tensioner 1145 and sensors 1130, 1135. Rather the testing area of the track 1610 (the second position 1665) is stationary in this safety check apparatus 1600. With this embodiment, the user 50 may be required to fully sit down into the harness 70 to determine whether the lanyard system passes (the user 50 is supported by the lanyard system) or fails (the user 50 falls to the supporting surface 1605) the safety test. In some embodiments, a logic controller 1655 controls operation of a test entry gate (not shown), a test exit gate 1625 and/or an indicator 1650 based on input received from course personnel supervising the safety testing. For example, a course operator may press a button or flip a switch to communicate testing status to the logic controller 1655. Otherwise, the previous description of components in reference to FIGS. 11 through 15 applies equally to, and therefore is not repeated for, the components of the safety check apparatus 1600 shown in FIGS. 16-19, including the supporting surface 1605, track 1610, gate 1625, indicator 1650, logic controller 1666, first track position 1660, first vertical distance 1665, second track position 1670, second vertical distance 1675, track access point 1900, track intersection 1910, course track ingress point 1920, course track egress point 1930, bypass track section 1940, bypass track one-way gate 1950, egress track one-way gate 1960, and staging area track section 1970.

In a modified embodiment of the safety check apparatus 1600 (not shown), the track 1610 comprises a force sensor in the testing area of the track 1610; the testing area corresponding to the second position 1670 of the track 1610 in the depicted embodiment. For example, the force sensor may be a force sensor pad provided along the surface of the track 1610 which contacts and supports the moveable member 80. In this case, the force sensor is configured to monitor and detect a load introduced into the lanyard system by measuring the force being applied to the force sensor by the moveable member 80. A force threshold may be selected as desired for a given application, which must be met or exceeded in the event of a passed test. If the force applied to the force sensor by the moveable member 80 meets or exceeds the selected force threshold, then the lanyard system will have successfully passed testing. The indicator 1650 indicates when the force measured by the force sensor meets or exceeds the selected force threshold. In some embodiments, the logic controller 1655 controls operation of the test entry gate (not shown), the test exit gate 1625 and/or the indicator 1650 based on input received from the force sensor indicating that a measured force has met or exceeded the selected force threshold. In some embodiments, the safety check apparatus 1600 comprises one or more hand elements and hand element sensors, as described above in reference to the safety check apparatus 1500, to ensure that a user 50 is not using his or her hands to pull down on the lanyard system and causing the force sensor to register a false positive.

In the depicted embodiments, the tracking 510, 610, 710, 810, 910, 1010, 1110, 1610 of the safety check apparatus 500, 600, 700, 800, 900, 1000, 1100, 1600 is connected to and transitions into, and may be integral with, the tracking 30 of the challenge course 10. This configuration allows the user 50 to continue directly into the challenge course 10 after going through the safety check apparatus 500, 600, 700, 800, 900, 1000, 1100, 1600. However, it should be appreciated that the safety check apparatus 500, 600 700, 800, 900, 1000, 1100, 1600 could instead be provided by a standalone structure offset from the challenge course 10. In that case, the track 510, 610, 710, 810, 910, 1010, 1110, 1610 would not be connected to the course track 30 of the challenge course 10. Rather, the user 50 would test his or her lanyard system on the separate safety check apparatus 500, 600, 700, 800, 900, 1000, 1100, 1600 before entering the challenge course 10. Then, the moveable member 80 could be removed from the track 510, 610, 710, 810, 910, 1010, 1110, 1610 of the safety check apparatus 500, 600, 700, 800, 900, 1000, 1100, 1600 and engaged to the actual course track 30 of the challenge course 10 at the course entrance 20.

The method for testing a lanyard system at an entrance to a challenge course, previously described above, may be performed using any of the depicted embodiments of the safety check apparatus 500, 600, 700, 800, 900, 1000, 1100, 1600.

While a number of aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and sub-combinations possible of the group are intended to be individually included in the disclosure.

In general, the terms and phrases used herein have their art-recognized meaning, which can be found by reference to standard texts, journal references and contexts known to those skilled in the art. The above definitions are provided to clarify their specific use in the context of the invention.

### LIST OF REFERENCE NUMERALS

10 challenge course
20 course entrance
30 course track
40 course element or obstacle
50 user
60 harness
70 lanyard
80 moveable member
90 carabiner
500 safety check apparatus
510 track
520 supporting surface
530 first position of track
535 vertical distance between first position and supporting surface
540 second position of track
545 vertical distance between second position and supporting surface
550 first portion of track
560 second portion of track
600 safety check apparatus
610 track
620 supporting surface
630 first position of track
635 vertical distance between first position and supporting surface
640 second position of track
645 vertical distance between second position and supporting surface
650 platform
700 safety check apparatus
710 track
720 supporting surface
730 first position of track
735 vertical distance between first position and supporting surface
740 second position of track
745 vertical distance between second position and supporting surface
750 platform
760 rail portion of track
770 elements
800 safety check apparatus
810 track
820 supporting surface
830 first position of track
835 vertical distance between first position and supporting surface
840 second position of track
845 vertical distance between second position and supporting surface
850 vertical dip
900 safety check apparatus
910 track
920 supporting surface
930 first position of track
935 vertical distance between first position and supporting surface
940 second position of track
945 vertical distance between second position and supporting surface
950 moveable portion of track
960 lift
1000 safety check apparatus
1010 track
1020 supporting surface
1030 first position of track
1035 vertical distance between first position and supporting surface
1040 second position of track
1045 vertical distance between second position and supporting surface
1100 safety check apparatus
1105 supporting surface
1110 track
1115 moveable track section
1120 first or test entry gate
1125 second or test exit gate
1130 moveable track sensor
1135 hand element sensors
1140 hand elements
1145 tensioner
1150 indicator
1155 logic controller
1160 first position of track
1165 vertical distance between first position and supporting surface
1170 second position of track
1175 vertical distance between second position and supporting surface
1500 track access point
1510 track intersection
1520 course track ingress point
1530 course track egress point
1540 bypass track section
1550 bypass track one-way gate
1560 egress track one-way gate
1570 staging area track section
1600 safety check apparatus
1605 supporting surface
1610 track
1625 test exit gate
1650 indicator
1655 logic controller
1160 first position of track
1165 vertical distance between first position and supporting surface
1170 second position of track
1175 vertical distance between second position and supporting surface
1900 track access point
1910 track intersection
1920 course track ingress point
1930 course track egress point
1940 bypass track section
1950 bypass track one-way gate
1960 egress track one-way gate
1970 staging area track section

1. A safety check apparatus for testing a lanyard system prior to entering a challenge course, comprising:
a track arranged at an entrance of the challenge course above a supporting surface, the track having a first position and a second position, the first position being a first vertical distance above the supporting surface, the second position being a second vertical distance above the supporting surface;
a moveable member supported by and displaceable relative to the track;
a lanyard attached to the moveable member and extending a length from the moveable member;
a harness having a connection point for coupling to a connection point of the lanyard;
wherein the track is connected to a course track that traverses the challenge course such that the moveable member is displaceable therebetween;
the first vertical distance of the first position of the track above the supporting surface is longer than the length of the lanyard;
the second vertical distance of the second position of the track above the supporting surface is longer than the length of the lanyard;
the first vertical distance of the first position of the track above the supporting surface is shorter than the second vertical distance of the second position of the track above the supporting surface;
whereby when at least a portion of a user's weight is supported by the harness, the connection point of the harness is positioned higher above the supporting surface at the second position of the track than at the first position of the track.

2. The safety check apparatus of claim 1, wherein the second vertical distance of the second position of the track is configured to load at least a majority of the user's weight onto the harness when the user is supported by the harness at the second position of the track.

3. The safety check apparatus of claim 2, wherein the second vertical distance of the second position of the track is configured to load at least 75% of the user's weight onto the harness when the user is supported by the harness at the second position of the track.

4. The safety check apparatus of claim 3, wherein the second vertical distance of the second position of the track is configured to load at least 95% of the user's weight onto the harness when the user is supported by the harness at the second position of the track.

4. The safety check apparatus of claim 4, wherein the second vertical distance of the second position of the track is configured to load all the user's weight onto the harness when the user is supported by the harness at the second vertical position of the track.

6. The safety check apparatus of any of the preceding claims, wherein the difference between the first vertical distance of the first position of the track and the second vertical distance of the second position of the track corresponds to the height that a user falls when the user steps or falls off an element of the challenge course before being caught by the lanyard, which is coupled to the harness and secured with respect to the course track traversing the challenge course via the moveable member.

7. The safety check apparatus of any of the preceding claims, wherein the first vertical distance of the first position of the track above the supporting surface is the same as the height between an element of the challenge course and a course track traversing said element.

8. The safety check apparatus of any of the preceding claims, wherein the first vertical distance of the first position of the track above the supporting surface is selected to make it easier for a user to reach the lanyard and move the moveable member connected to the lanyard along the track, at least compared to the second vertical distance of the second position of the track.

9. The safety check apparatus of any of the preceding claims, wherein the second vertical distance of the second position of the track above the supporting surface is selected to make it easier for a user to move from sitting in the harness to standing on the supporting surface, at least compared to the first vertical distance of the first position of the track.

10. The safety check apparatus of any of the preceding claims, wherein the lanyard comprises a plurality of connection points, and the connection point of the harness is coupled to the first adjacent connection point of the lanyard which is below the connection point of the harness when a user wearing the harness is standing under the second position of the track and the length of the lanyard is pulled downward from the moveable member in the track above.

11. The safety check apparatus of any of claim 1-10, wherein:
the supporting surface comprises a platform arranged underneath the track, the platform is displaceable between a first height and a second height, the first height of the platform being vertically higher than the second height of the platform:
the first position of the track is located above the platform when the platform is at the first height: and
the second position of the track is located above the platform when the platform is at the second height.

12. The safety check apparatus of claim 11, wherein the platform is actuated between the first height and the second height by a hydraulic or traction lift.

13. The safety check apparatus of claim 11 or 12, wherein the second vertical distance, which extends between the track and the platform when the platform is positioned at the second height, is configured to prevent a user's feet from contacting the platform when the platform is lowered to the second height.

14. The safety check apparatus of any of claims 1-10, wherein:
the track comprises a moveable portion that is displaceable between a first height and a second height, the second height of the moveable portion being vertically higher than the first height of the moveable portion;
the moveable portion of the track provides the first position of the track when the moveable portion is at the first height; and
the moveable portion of the track provides the second position of the track when the moveable portion is at the second height.

15. The safety check apparatus of claim 14, wherein the moveable portion of the track transitions into the course track that traverses the challenge course when the moveable portion of the track is positioned at the first height.

16. The safety check apparatus of claim 14 or 15, wherein the moveable portion of the track is actuated between the first height and the second height by a hydraulic or traction lift.

17. The safety check apparatus of any of claims 14-16, wherein the second vertical distance, which extends between the supporting surface and the moveable portion of the track when the moveable portion of the track is positioned at the second height, is configured to prevent a user's feet from contacting the supporting surface when the moveable portion of the track is raised to the second height.

18. The safety check apparatus of any of claims 1-10, wherein:
the supporting surface comprises an elevated platform underneath the track;
the track comprises a rail portion arranged above the supporting surface horizontally adjacent to the elevated platform;
the moveable member comprises one or more wheels configured to roll along the rail portion of the track;
the first position of the track is located above the elevated platform; and
the second position of the track is located in the rail portion of the track.

19. The safety check apparatus of claim 18, wherein the second vertical distance, which extends between the supporting surface and the rail portion of the track, is configured to prevent a user's feet from contacting the supporting surface when a user rolls along the rail portion of the track.

20. The safety check apparatus of any of claims 1-10, wherein:
the supporting surface comprises a vertical dip;
the second position of the track is located above the vertical dip of the supporting surface; and
the first position of the track is located above the supporting surface horizontally adjacent to the vertical dip.

21. The safety check apparatus of any of claims 1-10, wherein:
the track is inclined between the first position of the track and the second position of the track; and
the track is vertically higher at the second position than at the first position.

22. The safety check apparatus of any of the proceeding claims, wherein:
the track is connected to the course track traversing the challenge course at a course track ingress point;
the track has a test exit gate that is interchangeable between an open and closed position;
the test exit gate is arranged between the course track ingress point and the second position of the track; and
the test exit gate is configured to prevent a user from proceeding forward from the second position of the track to the course track until the user has completed testing.

23. The safety check apparatus of any of the proceeding claims, wherein:
the track is connected to the course track traversing the challenge course at a course track ingress point;
the track has a test entry gate that is interchangeable between an open and closed position;
the second position of the track is arranged between the course track ingress point and the test entry gate; and
the test entry gate is configured to prevent a user from proceeding forward to the second position of the track until a previous user has completed testing.

24. The safety check apparatus of claim 22 or 23, further comprising an indicator configured to visually indicate when the test exit gate and/or the test entry gate is/are open and/or closed.

25. The safety check apparatus of any of claims 22-24, wherein a logic controller controls operation of the test exit gate, the test entry gate, and/or the indicator based on input received from one or more sensors or from course personnel.

26. The safety check apparatus of any of claims 1-10, wherein:
the track comprises a moveable track section and a moveable track section sensor;
the moveable track section provides the second position of the track;
the moveable track section is vertically displaceable;
the moveable track section is upwardly biased by a biasing force provided by a tensioner;
the moveable track section is downwardly displaceable when a load, provided by a user sitting down in the harness or leaning into the harness, is applied which overcomes the biasing force of the tensioner; and
the moveable track section sensor is configured to detect displacement of the moveable track section; and
an indicator is configured to visually indicate when the moveable track section sensor detects that the moveable track section has been displaced.

27. The safety check apparatus of claim 26, wherein:
at least one hand element extends downward from the moveable track section;
each hand element is configured to be engaged by a user's hand;
at least one hand element sensor is configured to detect when a user has engaged with the at least one hand element; and
the indicator is configured to visually indicate when the at least hand element sensor detects that the at least one hand element has been engaged by a user.

28. The safety check apparatus of claim 26 or 27, wherein the track has a test entry gate configured to prevent a user from proceeding to the moveable track section until a previous user has completed testing.

29. The safety check apparatus of any of claims 26-28, wherein the track has a test exit gate configured to prevent a user from proceeding from the moveable track section to the course track until the user has completed testing.

30. The safety check apparatus of any of claims 26-29, further comprising a logic controller which processes signals received from the moveable track section sensor and/or the at least one hand element sensor, and controls operation of the indicator, the test entry gate, and/or the test exit gate based on said signals.

31. The safety check apparatus of any of claims 26-30, wherein the track is inclined between the first position of the track and the second position of the track, and the track is vertically higher at the second position than at the first position.

32. The safety check apparatus of any of the preceding claims, wherein the track comprises:
a track access point for mounting or dismounting the moveable member with respect to the track;
a course track ingress point for the moveable member to enter the course track from the safety check apparatus; and
a course track egress point for the moveable member to enter the safety check apparatus from the course track;
wherein the second position of the track is arranged along the track between the track access point and the course track ingress point.

33. The safety check apparatus of claim 32, wherein the track further comprises a bypass track section extending between the course track ingress point and the course track egress point.

34. The safety check apparatus of claim 33, wherein the bypass track section has a one-way gate configured to allow a user to move forward from the course track ingress point toward the course track egress point, but not from the course track egress point back toward the course track ingress point.

35. The safety check apparatus of any of claims 32-34, wherein the track has a one-way gate configured to allow a user to move from the course track egress point toward the course track access point, but not from the course track access point back toward the course track egress point.

36. The safety check apparatus of any of the preceding claims, wherein the track further comprises a staging area track section for fitting and/or unfitting users with components of the lanyard system.

37. The safety check apparatus of any of the preceding claims, wherein the harness is coupled to the lanyard via one or more carabiners.

38. A method for testing a lanyard system at an entrance to a challenge course, wherein a track is arranged at the entrance above a supporting surface and connected to a course track which traverses the challenge course, the method comprising the steps of:
coupling a connection point of a harness worn by a user to a connection point of a lanyard, wherein the lanyard is attached to a moveable member which is secured to and displaceable relative to the track, the lanyard extends a length from the moveable member, and the track comprises a first position and a second position, the first position being a first vertical distance above the supporting surface, the second position being a second vertical distance above the supporting surface, and the first vertical distance is shorter than the second vertical distance;
loading at least a portion of the user's weight onto the harness at the second position of the track, whereby the user's weight is supported by components that attach the user to the track in the event of a passed test, and whereby the user's weight is transferred to the supporting surface in the event of a failed test;
in the event of a passed test, allowing the user to proceed from the track to the course track of the challenge course; and
in the event of a failed test, preventing the user from proceeding from the track to the course track.

39. The method of claim 38, wherein at least a majority of the user's weight is loaded onto the harness.

40. The method of claim 39, wherein at least 75% of the user's weight is loaded onto the harness.

41. The method of claim 40, wherein at least 95% of the user's weight is loaded onto the harness.

42. The method of claim 41, wherein all the user's weight is loaded onto the harness.

43. The method of any of claims 38-42, further comprising:
in the event of a failed test, checking the components that attach the user to the track, refitting one or more components that attach the user to the track as determined by said checking, and retesting until there is a passed test before allowing the user to proceed from the track to course track of the challenge course.

44. The method of any of claims 38-43, further comprising:
opening a test entry gate along the track to allow the user with the moveable member to move into the second section of the track;
closing the test entry gate after the user with the moveable member moves into the second section of track to prevent a subsequent user with another moveable member from entering the second section of the track while the user is undergoing testing; and
in the event of a passed test, opening the test entry gate to allow the subsequent user with another moveable member to enter the second section of the track for testing.

45. The method of any of claims 38-44, further comprising:
in the event of a failed test, keeping a test exit gate along the track closed to prevent the user with the moveable member from moving out of the second section of track until there the user has a passed test; and
in the event of a passed test, opening the test exit gate to allow the user with the moveable to proceed to the course track of the challenge course, whereby the test exit gate is closed again once the user with the moveable member moves out of the second section of the track to prevent a subsequent user with another moveable member from bypassing testing.

46. The method of any of claims 38-45, further comprising:
changing the appearance of a visual indicator according to a testing status.

47. The method of any of claims 38-46, wherein when the user's weight is loaded onto the harness, the connection point of the harness is positioned higher above the supporting surface at the second position of the track than at the first position of the track.

48. The method of any of claims 38-47, wherein the difference between the first vertical distance of the first position of the track and the second vertical distance of the second position of the track corresponds to the height that a user falls when the user steps or falls off an element of the challenge course before being caught by the lanyard, which is coupled to the harness and secured with respect to the course track traversing the challenge course via the moveable member.

49. The method of any of claims 38-48, wherein the first vertical distance of the first position of the track above the supporting surface is the same as the height between an element of the challenge course and a course track traversing said element.

50. The method of any of claims 38-49, wherein the first vertical distance of the first position of the track above the supporting surface is selected to make it easier for the user to reach the lanyard and move the moveable member connected to the lanyard along the track, at least compared to the second vertical distance of the second position of the track.

51. The method of any of claims 38-50, wherein the second vertical distance of the second position of the track above the supporting surface is selected to make it easier for the user to move from sitting in the harness to standing on the supporting surface, at least compared to the first vertical distance of the first position of the track.

52. The method of any of claims 38-51, further comprising:
moving the lanyard with the moveable member attached into the second position of the track prior to coupling the harness to the lanyard, wherein the lanyard comprises a plurality of connection points, and the connection point of the harness is coupled to the first adjacent connection point of the lanyard which is below the connection point of the harness when the user wearing the harness is standing under the second position of the track and the length of the lanyard is pulled downward from the moveable member in the track above.

53. The method of any of claims 38-50, wherein the second vertical distance, which extends between the supporting surface and the second position of the track, is configured to prevent the user's feet from contacting the supporting surface when the user's weight is loaded onto the harness and the user is supported by components that attach the user to the track in the event of a passed test.

54. The method of claim 38-53, wherein the user falls to the supporting surface in the event of a failed test.

55. The method of any of claims 38-54, wherein the harness is coupled to the lanyard via one or more carabiners.

56. The method of any of claims 38-55 performed using the safety check apparatus according to any of claims 1-37.
